(19) United States
(12) Patent Application Publication
(10) Pub. No.: US 2013/0106220 A1
(43) Pub. Date: May 2, 2013

(54) BEARING ASSEMBLY AND SPINDLE MOTOR INCLUDING THE SAME

(71) Applicant: Ju Ho KIM, Seoul (KR)

(72) Inventor: Ju Ho KIM, Seoul (KR)

(73) Assignee: SAMSUNG ELECTRO-MECHANICS CO., LTD., Suwon (KR)

(21) Appl. No.: 13/346,154

(22) Filed: Jan. 9, 2012

(30) Foreign Application Priority Data
Oct. 27, 2011 (KR) 10-2011-0110643

(51) Int. Cl. H02K 7/08; F16C 32/06

(52) U.S. Cl. 310/90; 384/114

(57) ABSTRACT

There is provided a bearing assembly including: a sleeve supporting a shaft via oil; and at least one circulation part allowing upper and lower surfaces of the sleeve to be in communication with each other so that the oil is circulated, wherein a radial cross-sectional area of the circulation part on the upper surface of the sleeve is smaller than a radial cross-sectional area of the circulation part on the lower surface of the sleeve.

### CROSS-REFERENCE TO RELATED APPLICATIONS

This application claims the priority of Korean Patent Application No. 10-2011-0110643 filed on Oct. 27, 2011, in the Korean Intellectual Property Office, the disclosure of which is incorporated herein by reference.

### BACKGROUND OF THE INVENTION

1. Field of the Invention

The present invention relates to a bearing assembly and a spindle motor including the same, and more particularly, to a bearing assembly capable of being used in a hard disk drive (HDD) rotating a recording disk, and a spindle motor including the same.

2. Description of the Related Art

A hard disk drive (HDD), an information storage device, reads data stored on a disk or writes data to the disk using a read/write head.

The hard disk drive requires a disk driving device capable of driving the disk. In the disk driving device, a small-sized spindle motor is used.

In the small-sized spindle motor, a fluid dynamic bearing has been used. The fluid dynamic bearing is a bearing in which a shaft, a rotating member, and a sleeve, a fixed member, include oil interposed therebetween, such that the shaft is supported by fluid pressure generated in the oil.

The spindle motor as described above, according to the related art, includes a radial dynamic pressure generation groove for supporting rotation of the shaft and a thrust dynamic pressure generation groove for providing floating force. The rotating member rotates in a state in which it is floated at a predetermined height by the dynamic pressure generation grooves.

Here, when the spindle motor according to the related art is initially driven or is driven for an extended period of time, dynamic fluid pressure in the oil may fall in an inner portion of the spindle motor, such that negative (−) pressure, lower than atmospheric pressure, may be generated.

That is, when the pressure in the inner portion of the spindle motor becomes negative, an air component present in the oil may become air bubbles due to the low pressure.

These air bubbles may be introduced into the radial dynamic pressure generation groove or the thrust dynamic pressure generation groove such that normal dynamic pressure may not to be generated and vibrations and noise may be created.

Therefore, research into technology for improving spindle motor rotational characteristics by allowing air bubbles to be discharged to the outside thereof, without being introduced into a radial dynamic pressure generation groove or a thrust dynamic pressure generation groove, in the case in which the air bubbles are generated in the inner portion of the spindle motor, has been urgently demanded.

### SUMMARY OF THE INVENTION

An aspect of the present invention provides a bearing assembly capable of significantly reducing vibrations and noise and improving rotational characteristics by discharging air bubbles generated in an inner portion of a spindle motor to the outside, and a spindle motor including the same.

According to an aspect of the present invention, there is provided a bearing assembly including: a sleeve supporting a shaft via oil; and at least one circulation part allowing upper and lower surfaces of the sleeve to be in communication with each other so that the oil is circulated, wherein a radial cross-sectional area of the circulation part on the upper surface of the sleeve is smaller than a radial cross-sectional area of the circulation part on the lower surface of the sleeve.

The radial cross-sectional area of the circulation part may be linearly or non-linearly reduced in an upward axial direction.

An inclination angle formed by a radial cross section of the circulation part on the lower surface of the sleeve and a sidewall of the sleeve defining the circulation part may be in a range of 45 degrees to below 90 degrees.

The circulation part may move air bubbles present therein in an upward axial direction to thereby discharge the air bubbles outwardly.

The circulation part may include at least one step part formed between the upper and lower surfaces of the sleeve.

According to another aspect of the present invention, there is provided a spindle motor including: the bearing assembly as described above; a hub rotating with the shaft and having a magnet coupled thereto; and a base having a sleeve and a core coupled thereto, the core having a coil wound therearound and the coil generating rotational driving force through interaction with the magnet.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor including a bearing assembly according to an embodiment of the present invention;

FIG. 2 is a schematic cut-away perspective view showing a sleeve provided in a spindle motor according to an embodiment of the present invention;

FIG. 3 is a schematic enlarged cross-sectional view of part A of FIG. 1, showing a process of discharging air bubbles generated in the spindle motor according to the embodiment of the present invention to the outside; and

FIGS. 4 through 7 are schematic cross-sectional views showing modified examples of part A of FIG. 1.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, like reference numerals will be used to designate like components having similar functions throughout the drawings within the scope of the present invention.

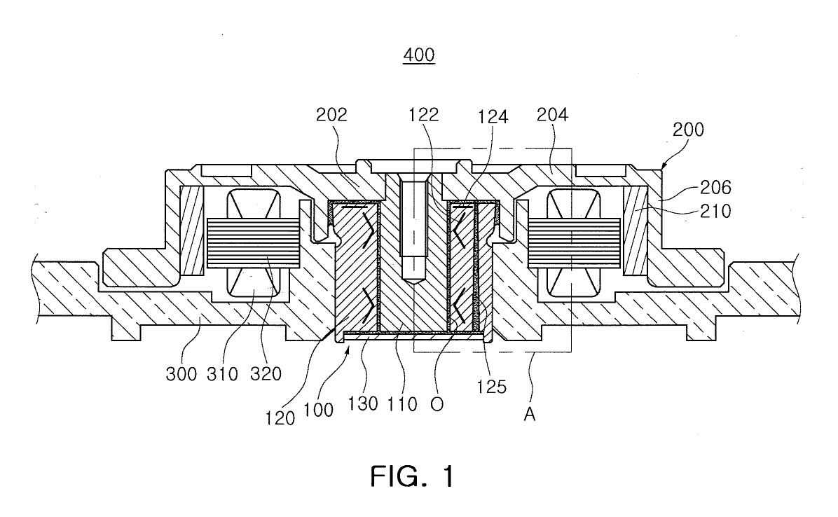

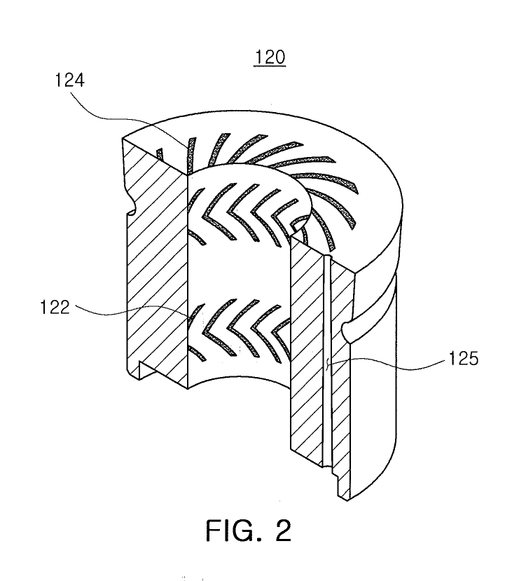

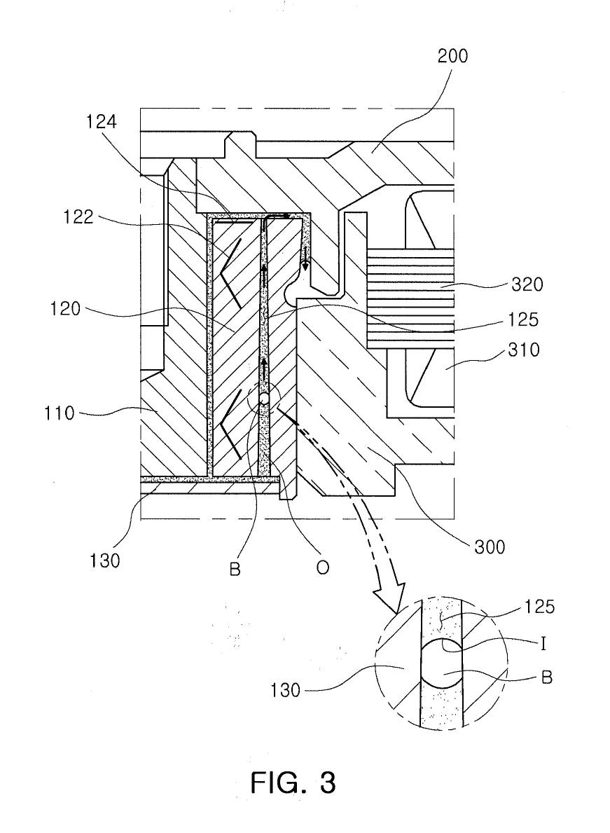

FIG. 1 is a schematic cross-sectional view showing a spindle motor including a bearing assembly according to an embodiment of the present invention; FIG. 2 is a schematic cut-away perspective view showing a sleeve provided in the spindle motor according to the embodiment of the present invention; and FIG. 3 is a schematic enlarged cross-sectional view of part A of FIG. 1, showing a process of discharging air bubbles generated in the spindle motor according to the embodiment of the present invention to the outside.

Referring to FIGS. 1 through 3, a spindle motor 400 including a bearing assembly 100 according to an embodiment of the present invention may include the bearing assembly 100 including a fluid dynamic bearing, a hub 200 having a magnet 210, and a base 300 including a core 320 having a coil 310 wound therearound.

Terms with respect to directions will be defined. As viewed in FIG. 1, an axial direction refers to a vertical direction based on a shaft 110, and an outer or inner radial direction refers to a direction towards an outer edge of the hub 200 based on the shaft 110 or a direction towards the center of the shaft 110 based on the outer edge of the hub 200.

In addition, a circumferential direction refers to a rotation direction of the shaft 110, that is, a direction corresponding to an outer peripheral surface of the shaft 110.

The bearing assembly 100 may include the shaft 110 and a sleeve 120.

The sleeve 120 may support the shaft 110 so that an upper end of the shaft 110 protrudes upwardly in the axial direction, and may be formed by performing a metal powder sintering process or the like using a metal material such as a Cu or SUS based alloy.

Here, the shaft 110 may be inserted into a shaft hole of the sleeve 120 while having a micro clearance therebetween. The micro clearance may be filled with oil O, and the rotation of the shaft 110 may be stably supported by a fluid dynamic pressure generation part 122 formed in at least one of an outer peripheral surface of the shaft 110 and an inner peripheral surface of the sleeve 120.

The fluid dynamic pressure generation parts 122 may form the fluid dynamic bearing capable of generating radial dynamic pressure via the oil O and may be formed in each of upper and lower portions of the sleeve 120 in order to more effectively support the shaft 110 by the radial dynamic pressure.

However, the fluid dynamic pressure generation parts 122 may also be formed in the outer peripheral surface of the shaft 110 as well as in the inner peripheral surface of the sleeve 120 as described above. In addition, the number of fluid dynamic pressure generation parts 122 is not limited.

Here, the fluid dynamic pressure generation part 122 may be a groove having a herringbone shape, a spiral shape, or a screw shape. However, the fluid dynamic pressure generation part 122 is not limited to having the above-mentioned shape but may have any shape as long as it may generate the radial dynamic pressure in the rotation of the shaft 110.

In addition, the sleeve 120 may have a thrust dynamic pressure generation part 124 formed on an upper surface thereof in order to generate thrust dynamic pressure via the oil. A rotating member including the shaft 110 and the hub 200 may rotate while being floated in a state in which a predetermined floating force is secured by the thrust dynamic pressure generation part 124.

Here, the thrust dynamic pressure generation part 124 may be a groove having a herringbone shape, a spiral shape, or a screw shape, similar to the fluid dynamic pressure generation part 122. However, the thrust dynamic pressure generation part 124 is not necessarily limited to having the above-mentioned shape but may have any shape as long as it may generate the thrust dynamic pressure.

In addition, the thrust dynamic pressure generation part 124 is not limited to being formed in the upper surface of the sleeve 120 but may also be formed in one surface of the hub 200 corresponding to the upper surface of the sleeve 120.

Here, the sleeve 120 may include a circulation part 125 formed therein. The circulation part 125 may be formed by allowing upper and lower surfaces of the sleeve 120 to be in communication with each other.

The circulation part 125 may be a circulation hole and allow for the dispersal of pressure from the oil O provided to the bearing assembly 100, while simultaneously circulating the oil O to thereby maintain balance in the pressure.

In addition, the circulation part 125 may be a discharge path allowing air bubbles B, or the like, generated in the inner portion of the bearing assembly 100 to be discharged by circulation.

More specifically, the spindle motor 400 including the bearing assembly 100 according to the embodiment of the present invention includes the fluid dynamic pressure generation part 122 and the thrust dynamic pressure generation part 124 as described above.

Here, when the spindle motor 400 is initially driven by receiving external power, radial dynamic pressure and thrust dynamic pressure may be generated in the oil O, and negative (−) pressure, lower than atmospheric pressure, may be generated in a predetermined position according to the strength and directions of the radial dynamic pressure and the thrust dynamic pressure.

However, a position in which the negative (−) pressure may be generated is not fixed, but may be variously changed according to structures of the fluid dynamic pressure generation part 122 generating the radial dynamic pressure and the thrust dynamic pressure generation part 124 generating the thrust dynamic pressure.

When the negative (−) pressure, lower than the atmospheric pressure, is generated in the inner portion of the bearing assembly 100 according to the embodiment of the present invention, air components present in the oil O generate the air bubbles B due to the low pressure.

These air bubbles B may be introduced into the fluid dynamic pressure generation part 122 or the thrust dynamic pressure generation part 124 to thereby prevent normal dynamic pressure generation, such that vibrations and noise may be caused and rotational characteristics are deteriorated.

Therefore, in the case in which the air bubbles B are generated in the inner portion of the spindle motor 400, the air bubbles B need to be discharged to the outside without being introduced into the fluid dynamic pressure generation part 122 or the thrust dynamic pressure generation part 124. In the bearing assembly 100 according to the embodiment of the present invention, the air bubbles B may be discharged by the circulation part 125.

A structural feature of the circulation part 125 will hereinafter be described. The circulation part 125 may be formed such that a radial cross-sectional area thereof on the upper surface of the sleeve 120 is smaller than a radial cross-sectional area thereof on the lower surface of the sleeve 120.

More specifically, the radial cross-sectional area of the circulation part 125 may be linearly reduced in the upward axial direction.

That is, a cross section of the circulation part 125 in the axial direction may have a shape in which it is narrowed from a lower portion of the circulation part 125 toward an upper portion thereof.

In addition, an inclination angle formed by the radial cross section of the circulation part 125 in the lower surface of the sleeve 120 and a sidewall of the sleeve 120 defining the circulation part 125 may be in the range of 45 degrees to below 90 degrees.

Therefore, in the case in which the air bubbles B are generated due to the generation of the negative (−) pressure in the inner portion of the bearing assembly 100 according to the embodiment of the present invention and are introduced into the circulation part 125, an interface I between the air bubble B and the oil O is generated.

Here, the interface I formed between the oil O and the air bubble B in the inner portion of the circulation part 125 has force applied thereto in order to move the interface I in the upward axial direction through a capillary phenomenon.

In other words, since the oil O has a reduced surface area due to surface tension, the oil O has a property in which it reduces a size of the interface I between the oil O and the air bubble B.

Therefore, since the interface I between the oil O and the air bubble B is reduced within the circulation part 125 in the upward axial direction, the air bubble B may move in the upward axial direction as shown by an arrow.

The upward movement of the air bubble B in the axial direction as described above may be implemented by linearly reducing the radial cross section of the circulation part 125 in the upward axial direction.

Here, the air bubble B moved from the inner portion of the circulation part 125 upwardly in the axial direction may move to the atmospheric pressure side. As a result, the air bubble B may be discharged to the outside without moving to a clearance between the shaft 110 and the sleeve 120.

Therefore, even in the case in which the air bubbles B are generated due to the generation of the negative (−) pressure, which is lower than the atmospheric pressure, in the inner portion of the bearing assembly 100 according to the embodiment of the present invention, the air bubbles B may be discharged to the outside along the circulation part 125, whereby vibrations and noise due to the air bubbles B may be significantly reduced and rotational characteristics may be improved.

Here, the lower portion of the sleeve 120 maybe coupled to a base cover 130 so as to close the lower portion thereof. Here, the base cover 130 may have a clearance with respect to the shaft 110 and the sleeve 120, such that the clearance is filled with the oil O.

The bearing assembly 100 according to the embodiment of the present invention may be formed to have a full-fill structure by the base cover 130. More specifically, the oil O provided to the bearing assembly 100 may be continuously filled in the clearance between the shaft 110 and the sleeve 120, in the clearance between the shaft and sleeve 110 and 120 and the base cover 130, and in the clearance between the sleeve 120 and the hub 200.

The hub 200 may be a rotating structure rotatably provided with respect to the fixed member including the base 300.

In addition, the hub 200 may include an annular ring shaped magnet 210 provided on an inner peripheral surface thereof, and the annular ring shaped magnet 210 corresponds to the core 320, having a predetermined interval therebetween.

More specifically, the hub 200 may include a first cylindrical wall part 202 fixed to an upper end of the shaft 110, a disk part 204 extended from an end portion of the first cylindrical wall part 202 in the outer radial direction, and a second cylindrical wall part 206 protruding downwardly from an end portion of the disk part 204 in the outer radial direction, and the second cylindrical wall part 206 may include the magnet 210 coupled to an inner peripheral surface thereof.

The base 300 may be a fixed member supporting the rotation of the rotating member including the shaft 110 and the hub 200.

Here, the base 300 may include the core 320 coupled thereto, and the core 320 has the coil 310 wound therearound. The core 320 may be fixedly disposed on an upper portion of the base 300 including a printed circuit board (not shown) having a circuit pattern printed thereon.

In other words, the outer peripheral surface of the sleeve 120 and the core 320 having the coil 310 wound therearound may be inserted into the base 300, such that the sleeve 120 and the core 320 are coupled to the base 300.

Here, as a method of coupling the sleeve 120 and the core 320 to the base 300, a bonding method, a welding method, a press-fitting method, or the like, may be used. However, the coupling method is not necessarily limited thereto.

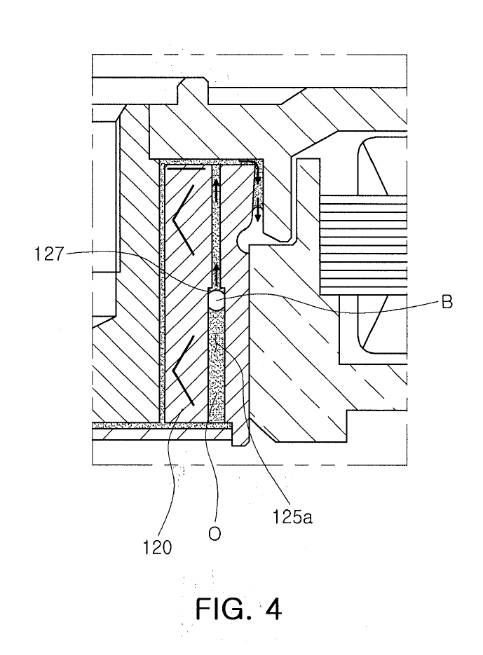

FIGS. 4 through 7 are schematic cross-sectional views showing modified examples of part A of FIG. 1.

Referring to FIG. 4, a circulation part 125a allowing the upper and lower surfaces of the sleeve 120 to be in communication with each other may include at least one step part 127 formed between the upper and lower surfaces of the sleeve 120.

More specifically, the step part 127 may cause a difference in a diameter of the circulation part 125a. In the case in which a single step part 127 is formed as shown in FIG. 4, an upper diameter of the circulation part 125a may be smaller than a lower diameter of the circulation part 125a.

Therefore, the circulation part 125a may be formed such that a radial cross-sectional area thereof on the upper surface of the sleeve 120 is smaller than a radial cross-sectional area thereof on the lower surface of the sleeve 120.

Therefore, in the case in which the air bubbles B are generated due to the generation of the negative (−) pressure, which is lower than the atmospheric pressure, in the inner portion of the bearing assembly 100 according to the embodiment of the present invention and are introduced into the circulation part 125a, the air bubbles may be discharged to the outside without being re-introduced into the shaft 110 and the sleeve 120.

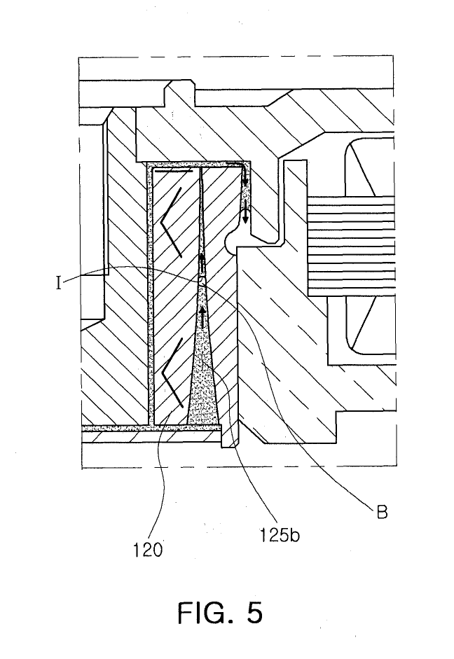

Referring to FIG. 5, a circulation part 125b allowing the upper and lower surfaces of the sleeve 120 to be in communication with each other may have a radial cross-sectional area non-linearly reduced in the upward axial direction.

Therefore, when the air bubble B is introduced into the circulation part 125b, an interface I between the oil O and the air bubble B may be formed in an inner portion of the circulation part 125b and the air bubble B may move upwardly in the axial direction as shown by an arrow due to surface tension of the oil O.

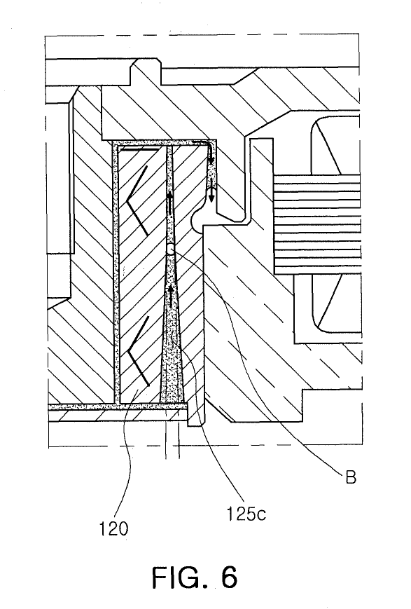

Referring to FIG. 6, in a circulation part 125c allowing the upper and lower surfaces of the sleeve 120 to be in communication with each other, the rates at which a diameter of the circulation part 125c is reduced in the upward axial direction may be different.

That is, the rate may be lower in a lower portion of the circulation part 125c than in an upper portion of the circulation part 125c.

In addition, the circulation part 125c may be formed such that a radial cross-sectional area thereof on the upper surface of the sleeve 120 is smaller than a radial cross-sectional area thereof on the lower surface of the sleeve 120, similar to the above-mentioned embodiment.

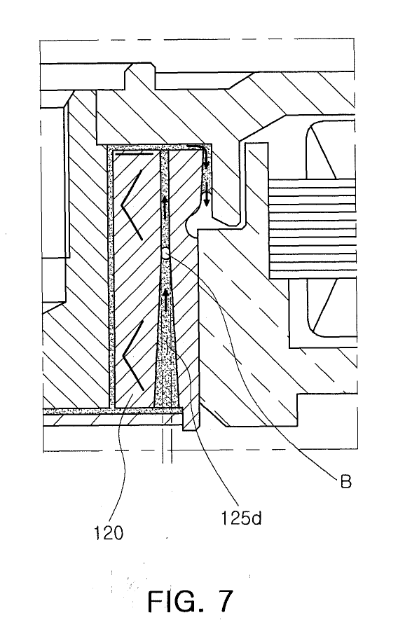

Referring to FIG. 7, a circulation part 125d allowing the upper and lower surfaces of the sleeve 120 to be in communication with each other may have a diameter linearly reduced in the upward axial direction from a lower portion of the circulation part 125d to a point at a predetermined height and be then maintained to be constant.

As described above, in the bearing assembly 100 and the spindle motor 400 including the same according to the embodiments of the present invention, even in the case in which the air bubbles B are generated due to the generation of the negative (−) pressure, which is lower than the atmospheric pressure, in the inner portion of the bearing assembly 100, the air bubbles B are discharged to the outside through the circulation part 125, 125a, 125b, 125c, or 125d, whereby the vibration and rotational characteristics may be improved.

As set forth above, in a bearing assembly and a spindle motor including the same according to embodiments of the present invention, air bubbles generated in the inner portion of the spindle motor are rapidly discharged to the outside, whereby vibrations may be reduced and rotational characteristics may be improved.

While the present invention has been shown and described in connection with the embodiments, it will be apparent to those skilled in the art that modifications and variations can be made without departing from the spirit and scope of the invention as defined by the appended claims.

What is claimed is:

1. A bearing assembly comprising:
a sleeve supporting a shaft via oil; and
at least one circulation part allowing upper and lower surfaces of the sleeve to be in communication with each other so that the oil is circulated,
wherein a radial cross-sectional area of the circulation part on the upper surface of the sleeve is smaller than a radial cross-sectional area of the circulation part on the lower surface of the sleeve.

2. The bearing assembly of claim 1, wherein the radial cross-sectional area of the circulation part is linearly or non-linearly reduced in an upward axial direction.

3. The bearing assembly of claim 1, wherein an inclination angle formed by a radial cross section of the circulation part on the lower surface of the sleeve and a sidewall of the sleeve defining the circulation part is in a range of 45 degrees to below 90 degrees.

4. The bearing assembly of claim 1, wherein the circulation part moves air bubbles present therein in an upward axial direction to thereby discharge the air bubbles outwardly.

5. The bearing assembly of claim 1, wherein the circulation part includes at least one step part formed between the upper and lower surfaces of the sleeve.

6. A spindle motor comprising:
the bearing assembly of claim 1;
a hub rotating with the shaft and having a magnet coupled thereto; and
a base having a sleeve and a core coupled thereto, the core having a coil wound therearound and the coil generating rotational driving force through interaction with the magnet.
